(19) United States
(12) Patent Application Publication
(10) Pub. No.: US 2026/0152258 A1
(43) Pub. Date: Jun. 4, 2026

(54) SLIDING BLOCK WITH PLASTIC RUNNERS

(71) Applicant: Darran Lane Wardle, Eagle Point, OR (US)

(72) Inventor: Darran Lane Wardle, Eagle Point, OR (US)

(21) Appl. No.: 18/969,017

(22) Filed: Dec. 4, 2024

(51) Int. Cl. B63B 17/04; A01K 97/10; B60R 11/00

(52) U.S. Cl. CPC B63B 17/04; A01K 97/10; B60R 11/00; B60R 2011/0084; B63B 2017/045

(57) ABSTRACT

Various embodiments relate to a rail track system that includes a sliding block. The sliding block may include a body portion that is configured to traverse a length of a rail when the sliding block is coupled with the rail. The sliding block may further include a runner that protrudes from a surface of the sliding block that is adjacent to the rail, wherein the runner prevents the surface of the sliding block from being in contact with the rail when the sliding block is coupled with the rail. Other embodiments may be described and claimed.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

As used herein, the term “rail track system” may refer to a configuration wherein a connecting block may be couplable with a rail and configured to traverse a length of the rail. The rail track system may be attached on a vehicle. For example, a rail track system may be used on a boat. The rail may be attached to the side of the boat. A user may have an accessory that is capable of coupling with the block. For example, the block may be, or may be couplable to, a fishing rod holder. In this manner, the fishing rod holder (and, subsequently, the user's fishing rod) may be capable of traversing the rail so that it can slide from one end of the boat to another.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIGS. 1a and 1b (collectively, “FIG. 1”) illustrate images of a use case wherein an example rail track system is coupled with a boat, in accordance with various embodiments.

FIG. 2 is a highly simplified example of a top-down view of a rail track system, in accordance with various embodiments.

FIG. 3 is a highly simplified example top-down view showing a cross-section of a block, in accordance with various embodiments.

FIG. 4 is a highly simplified cross-sectional view of an example rail track system, in accordance with various embodiments.

FIG. 5 is a highly simplified cross-sectional view of an alternative example rail track system, in accordance with various embodiments.

FIG. 6 is a highly simplified cross-sectional view of an alternative example rail track system, in accordance with various embodiments.

FIG. 7 is a highly simplified cross-sectional view of an alternative example rail track system, in accordance with various embodiments.

FIG. 8 is a highly simplified example cross-sectional view of a block and runner, in accordance with various embodiments.

FIG. 9 is an example cross-sectional view of a commercial embodiment of a block and runner, in accordance with various embodiments.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Various embodiments herein provide a rail track system that includes a rail and a block. A rail track system may also be referred to as an accessory rail system, a track rail, a fishing rod sliding rail, a rod holder track, a rod slide, a sliding rod slide, a tie down track system, or a track tie down. It will be understood that this list is provided for the sake of non-limiting examples of various use cases and may be referred to by a different term in different embodiments/use cases. It will also be understood that embodiments herein may be described with respect to the use of a rail track system attached to a boat. However, in other embodiments the rail track system may be coupled with a different vehicle such as an all-terrain vehicle (ATV), a truck, a car, a long-haul trailer, and/or some other type of vehicle. In some embodiments, the rail track system may be used in an alternative non-vehicular use case.

As previously mentioned, a rail track system may include a block that is capable of coupling with a rail and traversing a length of the rail. However, in some legacy configurations, undesirable materials such as sand, salt, rocks, etc. may become present between the block and rail. As such, when the block traverses the rail, the material may cause one or both of the block and rail to become scratched and/or damaged. Additionally or alternatively, any sort of manufacturing defects or impurities in the block and/or rail may cause the block and rail to rub against one another. In this situation, the block and/or rail may also become scratched and/or damaged. As such, the rail block system in the present embodiment includes a block with runners that prevents the block and/or rail from rubbing against one another.

In embodiments herein, a surface of the block that faces the rail may include protruding runners that contact the rail. These runners may provide separation between the block and rail, and therefore help the rail track system from corrosion and scratching because the block may not rub against the rail.

It will be understood that, in descriptions herein, the rails and/or blocks may be described as being formed of metal and, particularly, aluminum. However, in other embodiments the rails and/or blocks may at least partially be formed of some other metal material such as stainless steel and/or some other material that may be resistant to rust and/or oxidation (e.g., in marine environments). In other embodiments the rails and/or blocks may additionally/alternatively be at least partially formed of another material such as plastic, carbon fiber, ceramic, wood, etc. In some embodiments, the rails and blocks may be formed of the same material, while in other embodiments the rails and blocks may be formed of a different material than one another.

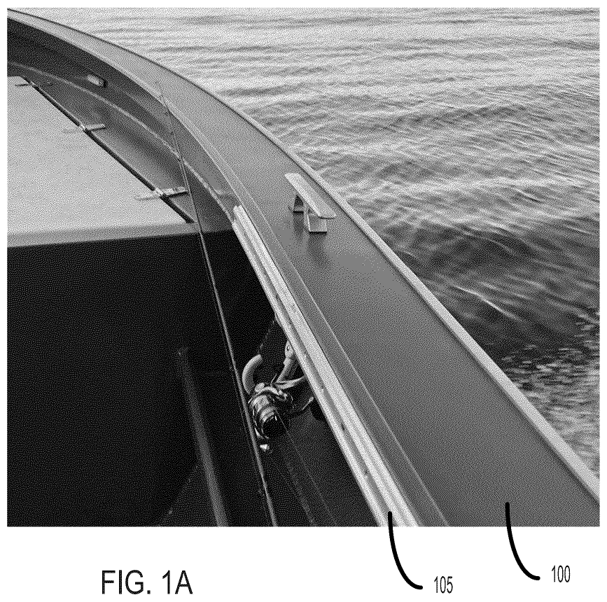

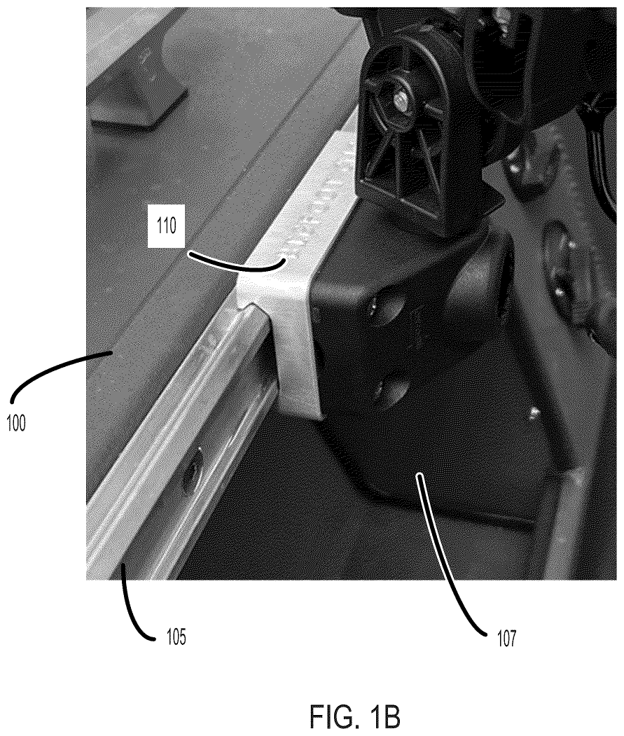

FIG. 1 illustrates images of a use case wherein an example rail track system is coupled with a boat 100, in accordance with various embodiments. As previously noted, this particular use case is intended as one example use case. In other embodiments, the rail track system may be used on or with some other types of vehicles such as a car, a truck, an off-road vehicle, an ATV, etc. For example, the rail track system may be installed on a truck or car's roof rack; it may also be installed as a truck bed rail. In some embodiments, multiple rail track systems may be used on a single vehicle.

As an example, FIG. 1A depicts an example wherein a rail 105 is attached to an inner side of a gunwale of a boat 100. FIG. 1B depicts an alternative example wherein a rail 105 is attached to an inner side of a gunwale of a boat 100. As may be seen, a block 110 may be coupled with the rail 105 such that it may slide laterally along the gunwale of the boat. Additionally, as previously described, an attachment 107 may be coupled with the block 110. In this embodiment, the attachment 107 may be a holder for a fishing rod. In an embodiment, the attachment 107 is used for a plier pouch. In an embodiment, the attachment 107 is used for a cup holder. In an embodiment, the attachment 107 is used for a table mount. In an embodiment, the attachment 107 is used for a bait station. In an embodiment, the attachment 107 is used for a knife holder. In an embodiment, the attachment 107 is used for a scissor holder. In an embodiment, the attachment 107 is used for a cooler. While a number of different uses for the attachment 107 has been described, alternative embodiments may include other uses for attachment 107.

It will be noted that, in the embodiment of FIG. 1, the rail 105 is shown only as attached to an inner gunwale of the boat 100. However, in other embodiments, one or more rails 105 may additionally/alternatively be attached at some other location on the boat 100 (e.g., outside of the gunwale, on top of the gunwale, etc.).

Similarly, in other embodiments or use cases, a rail 105 may be attached in a variety of locations in or on a vehicle. For example, a rail 105 may be installed on top of a car's roof rack. In some embodiments, a rail 105 need not be straight. Generally, it will be understood that factors such as the location of the rail, the shape of the rail, the number of rails, the attachment coupled with the rail, the shape and/or size of the block, etc. may vary based on, for example, the use case to which the rail track system will be put, user preference, material availability, etc. The embodiments discussed herein are intended as examples for the sake of discussion but are not intended to be limiting unless otherwise explicitly stated.

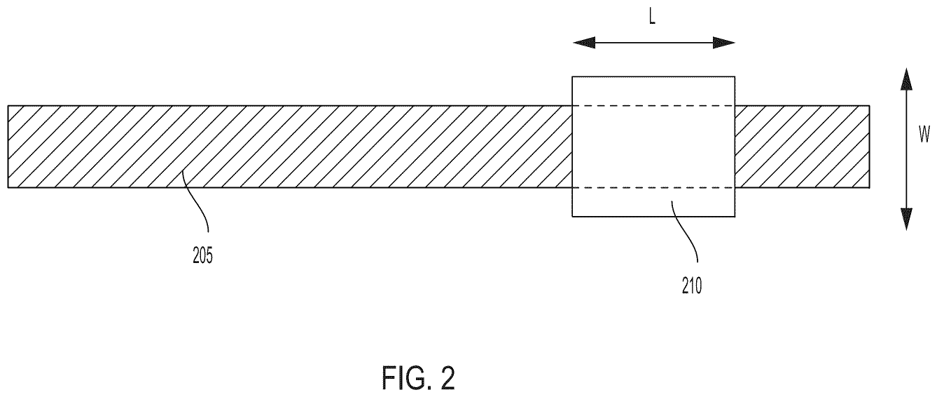

FIG. 2 is an example of a top-down view of a rail track system, in accordance with various embodiments. In the present embodiment, only one block 210 is shown. However, a rail track system may have more than one block 210. As previously noted, the number of blocks, shape of blocks, etc. may depend on factors such as the specific application of the user. The block 210 may be configured to traverse the rail 205 along direction L as shown.

In some embodiments, the block 210 may have a length (as measured along the axis L) of between approximately 2 inches (″) and approximately 8″. The block 210 may have a width (as measured along the axis W) of between approximately 0.5″ and approximately 6″. The block 210 may have a height (as measured along an axis H perpendicular to both W and L, as shown for example in FIG. 4) of between approximately 0.5″ and approximately 2″.

Similarly, the rail 205 may have a length of approximately customizable to a variety of lengths. The length of the rail 205 may, for example, be based on factors such as the vehicle to which the rail 205 will be mounted, the use case for the rail track system, user preference, etc. The rail 205 may have a width of approximately ½″-6″. The rail 205 may have a height of approximately ½″ to 1″ (thickness ⅝″ currently).

It will be understood that the above dimensions are intended as examples of one embodiment for the sake of discussion. In other embodiments, one or both of the rail 205 and the block 210 may have a different height, width, and/or length. Such variation may be based on, for example, the material used in the construction of the rail track system, the use case to which the rail track system will be put, etc.

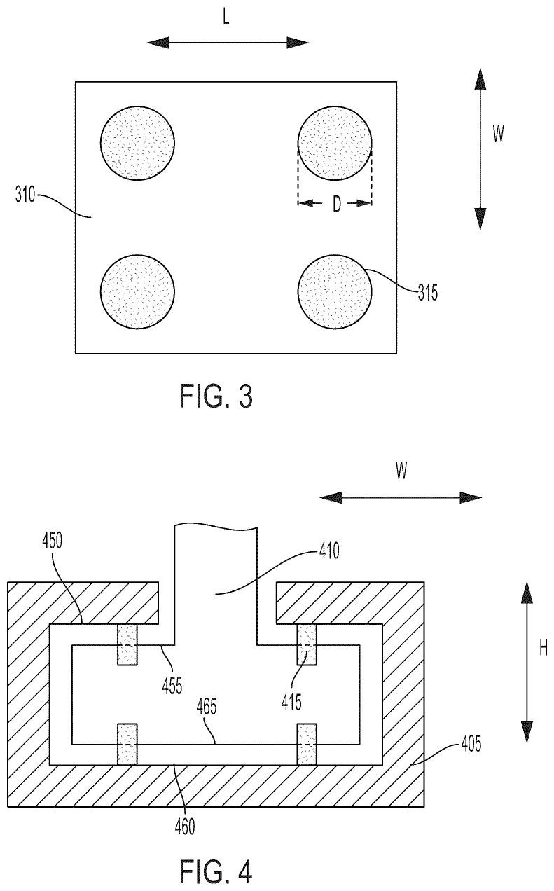

FIG. 3 is a highly simplified example top-down view showing a cross-section of a block 310, in accordance with various embodiments. The block 310 may be similar to, and share one or more characteristics with, blocks 110 or 210. The block 310 may include one or more runners 315 as shown in FIG. 3. As described in greater detail below, the runners 315 may at least partially protrude from the face of the block 310 that is adjacent to a rail such as rail 205. As such, the runners 315 may physically separate the block 310 from the rail to reduce or eliminate the undesirable physical degradation of one or both of the block 310 and the rail as previously described.

The present embodiment shows four runners 315 on the block 310 placed near the four corners of the block 310. However, it is to be understood by a person of ordinary skill that there can be various number of runners 315 on a block 310 and their placement need not be at the corner of the block 310. In some embodiments, there could be five runners 315 where four runners 315 are at the corner of the 310 and one of the runners 315 is placed at the center of the block 310. Other variations may be present in other embodiments.

The runners 315 may be made of plastic and/or some other material. For example, the plastic may be or include one or more of: ultra high molecular weight polyethylene (UHMW), polyoxymethylene, or Delrin. In other embodiments, the plastic may be or include some other type of plastic. In some embodiments, the runners 315 may additionally or alternatively include some other material such as a metal material (e.g., a metal core), a wood material, and or some other material.

Similarly, it will be understood that the runners 315 in the present embodiment are depicted as having a round cross-section with a diameter D of between approximately 0.5 inches and approximately 0.75 inches, but may be some other shape and/or size in other embodiments. For example, in some embodiments, one or more of the runners 315 may have a cross-sectional shape such as a square shape, a triangular shape, a hexagonal shape, an irregular shape, an oval shape, or some other shape. In some embodiments, a block 310 may have one or more runners that are a different size or shape of another of the runners 315. For example, in some embodiments involving a block 310, there may be a first runner 315 in the shape of a long oval that sits horizontally on the top of the block 310 and a second runner 315 in the shape of an oval that sits horizontally on the bottom of the block 310. In some embodiments, one or more of the runners 315 may not have a persistent shape along a height of the runner. For example, the runner may “flare out” or have a larger diameter at a portion of the runner inside of the block 310. Such a configuration may be desirable to retain the runner within the block. Other variations may be present in other embodiments.

In the present embodiment, the block 310 has runners 315 that are all the same shape. In other embodiments, the runners 315 do not have to be the same shape. Instead, a combination of different shaped runners 315 may be used. Similarly, a combination of runners 315 that are made of different materials may be used. For example, out of four runners 315, one may have a metal core and have a round cross-section, the second may have a metal core and have an oval cross-section, the third may have a wooden core and have an irregular cross-section, and the fourth may be entirely plastic and have a triangular cross-section. Other variations may be present.

FIG. 4 is a highly simplified cross-sectional view of an example rail track system, in accordance with various embodiments. Specifically, FIG. 4 depicts a rail 405, a block 410, and a plurality of runners 415, which may be respectively similar to, and share one or more characteristics with, rails 105/205, block 110/210/310, and runner 315.

The rail 405 may be a generally closed-U-shaped female connector, and the block 410 will have a corresponding T-shaped male connector to be able to couple to the rail 405 (e.g., by sliding into an open end of the rail). This figure shows a block surface 455 with runners 415 protruding to help position the face 455 of the block 410 away from the face 450 of the rail 405. Similarly, runners 415 may be positioned at face 465 of block 410 to separate the face 465 from the face 460 of the rail 405. In this way, the block 410 may traverse the length of the rail 405 while avoiding the above-described physical degradation caused by friction of the block face(s) against the rail face(s).

In the present embodiment, there are four runners 415 depicted, but in other embodiments, more or fewer runners 415 may be used. For example, in some embodiments, additional runners 415 may be placed next to the runners 415 depicted in FIG. 4. In other embodiments, runners 415 may be placed on the side that is perpendicular to the block surface 455. In some embodiments, only a single runner may protrude from face 465. Other embodiments may vary.

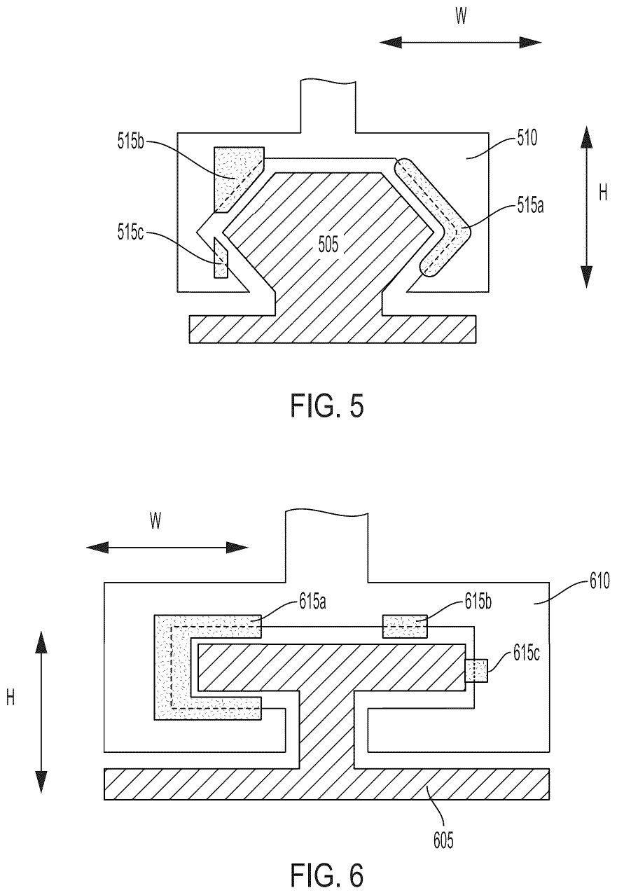

FIG. 5 is a highly simplified cross-sectional view of an alternative example rail track system, in accordance with various embodiments. The rail track system of FIG. 5 may include a rail 505, a block 510, and plurality of runners (515a, 515b, and 515c, collectively runners 515), which may be respectfully similar to, and share one or more characteristics with, one or more of the rail(s), block(s), and runner(s) described with respect to other embodiments herein. Rail 505 may be a generally hexagonal male connector, and block 510 may be configured as a generally hexagonal female connector will correspond to be able to couple to the rail 505. This cross-section shows that the runners 515 may have a variety of distributions that conform to the type and shape of the block 510.

For example, runner 515a may generally contact both an upper portion and a lower portion of the rail 505. Specifically, a single runner 515 may protrude from two faces of the block 510, and contact two faces of the rail 505. Additionally or alternatively, a runner 515 may only protrude from a single surface of the block 510, and contact only a single surface of the rail 505. Examples of such runners are shown at runners 515b and 515c. In some embodiments, the shape and/or size of the runner 515 may be dependent on the shape of the block 510 from which the runner 515 protrudes. For example, runner 515b is shown as having a greater width than runner 515c. This greater width may be because the block 510 is relatively thicker at a top portion of the block 510 (e.g., a portion furthest from rail 505), where runner 515b is located, than a bottom portion of the block 510. As a result, it may be possible for the runner 515b to be larger than runner 515c.

FIG. 6 is a highly simplified cross-sectional view of an alternative example rail track system, in accordance with various embodiments. The rail track system of FIG. 6 may include a rail 605, a block 610, and plurality of runners (615a, 615b, and 615c, collectively runners 615), which may be respectfully similar to, and share one or more characteristics with, one or more of the rail(s), block(s), and runner(s) described with respect to other embodiments herein. Rail 605 may be configured as a generally T-shaped male connector, and block 610 may have a corresponding female connector able to couple to the rail 605 (e.g., by sliding the block 610 onto the end of the rail 605).

Similarly to FIG. 5, the runners 615 of FIG. 6 may have a variety of form factors. For example, runner 615a may protrude from a plurality of faces of block 610, and subsequently contact a plurality of faces of the rail 605, in a manner similar to that of runner 515a described above. Runner 615b may contact only a single face of rail 605 (e.g., the top face). Runner 615c may contact only a single face of rail 605 (e.g., a side face of rail 605).

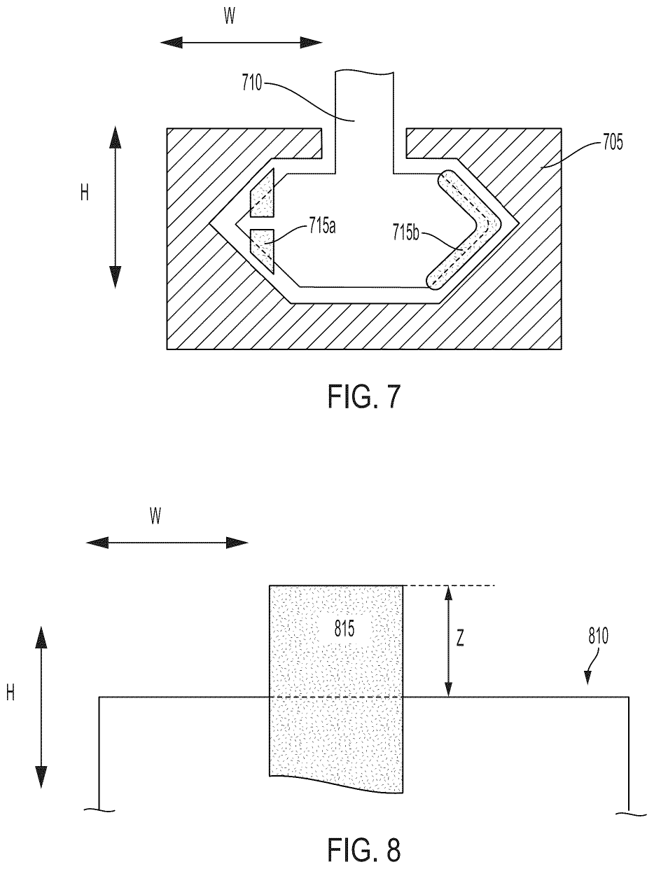

FIG. 7 is a highly simplified cross-sectional view of an alternative example rail track system, in accordance with various embodiments. The rail track system of FIG. 7 may include a rail 705, a block 710, and plurality of runners (715a and 715b, collectively runners 715), which may be respectfully similar to, and share one or more characteristics with, one or more of the rail(s), block(s), and runner(s) described with respect to other embodiments herein. In the embodiments of FIG. 7, the rail 705 may be configured as a generally hexagonal female connector, and the block 710 may be configured as a male connector that is able to couple to the rail 705 (e.g., by sliding on to an end of the rail 705).

In the present embodiment, two, generally similarly shaped, runners 715a may protrude from two generally opposite faces of the block 710 such that each of the runners 715a contacts a single face of the rail 705. Additionally or alternatively, a single runner 715b may protrude from at least two faces of the block 710 such that a single runner contacts at least two faces of the rail 705.

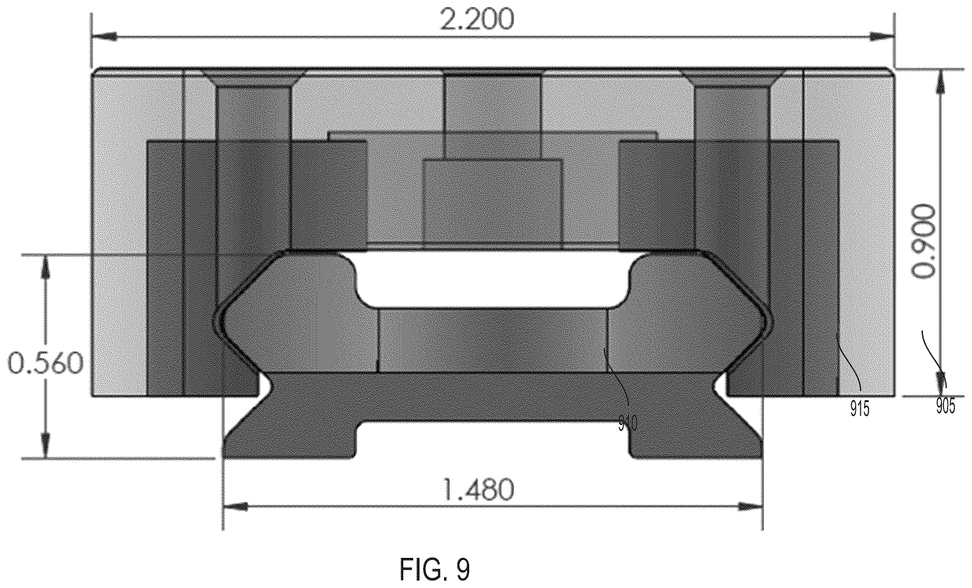

FIG. 9 depicts an example cross-sectional view of a block 910, rail 905, and runner 915, in accordance with various embodiments. The block 910, runner 915, and rail 905 may be similar to, and share one or more characteristics with, other example blocks/runners/rails described herein. The embodiment depicted in FIG. 9 depicts details of a commercial embodiment as may be manufactured and/or sold. Various dimensions, as measured in inches, are also shown in FIG. 9.

It will be understood that the embodiments depicted and described herein are intended for the sake of discussion of various concepts. Unless otherwise indicated, specific dimensions, shapes, sizes, orientations, numbers or relative sizes of various elements, etc. should not be inferred from the Figures. Various other embodiments may include one or more variations from the depictions herein. For example, some embodiments may have more or fewer runners, different cross-sectional shapes, runners in different locations than depicted, etc. Some embodiments may have a plurality of blocks, a plurality of rails, etc. Other variations may be present.

FIG. 8 is a highly simplified example cross-sectional view of a block 810 and runner 815, in accordance with various embodiments. The block 810 and runner 815 may be generally similar to, and share one or more characteristics with, one or more of the blocks and/or runners as described herein. In the embodiment of FIG. 8, the runner 815 protrudes from the block 810 with a height Z. In some embodiments, Z may be between approximately 0.05 thousandths of an inch and approximately 0.15 thousandths of an inch. In other embodiments, the value of H may be higher or lower. For example, in some embodiments Z may be higher or lower dependent upon the application of the rail track system. In an embodiment, Z may need to higher because the amount of force the block exerts on the rail is large. In an embodiment, Z may be lower because the force the block exerts on the rails is small. In an embodiment, Z may be higher or lower due to design limitations. While a number of different situations where Z may vary has been described, alternative embodiments may involve different use cases and/or considerations.

In the present embodiment, the runner 815 is depicted to be rectangular. That is, it has a height, H, and a generally flat top. However, as mentioned above, the runner 815 may have a different shape in various embodiments. As an example, the portion of the runner 815 that protrudes from block 810 may have a rounded cross-section. In this embodiment, the cross-sectional view of the runner 815 may be a generally concave parabola with Z being measured from the block 810 to the vertex of the runner 815.

Some non-limiting examples of various embodiments are provided below.

Example 1 may include a sliding block comprising: a body portion that includes a metal material, wherein the body portion is configured to traverse a length of a rail when the sliding block is coupled with the rail, and wherein the body portion includes a first face that is adjacent to a second face of the rail when the sliding block is coupled with the rail; and a runner that protrudes from the first surface, wherein the runner prevents the first surface from being in contact with the second surface when the sliding block is coupled with the rail.

Example 2 may include the sliding block of example 1, any/or some other example herein, wherein the rail is configured to be mounted to a vehicle.

Example 3 may include the sliding block of example 2, and/or some other example herein, wherein the vehicle is a boat, a truck, or an all-terrain vehicle (ATV).

Example 4 may include the sliding block of any one or more of examples 1-3, and/or some other example herein, wherein the runner is a plastic runner.

Example 5 may include the sliding block of any one or more of examples 1-4, and/or some other example herein, wherein the runner protrudes from the first surface by between 0.05 and 0.15 thounsandths of an inch.

Example 6 may include the sliding block of any one or more of examples 1-5, and/or some other example herein, wherein the metal material is aluminum.

Example 7 may include the sliding block of any one or more of examples 1-6, and/or some other example herein, wherein the rail includes aluminum.

Example 8 may include the sliding block of any one or more of examples 1-7, and/or some other example herein, wherein the body portion includes two or more runners that protrude from the first surface.

Example 9 may include the sliding block of any one or more of examples 1-8, and/or some other example herein, wherein the body portion is configured as a female connector and the rail is configured as a male connector.

Example 10 may include the sliding block of any one or more of examples 1-9, and/or some other example herein, wherein the body portion is configured as a male connector and the rail is configured as a female connector.

Example 11 may include the sliding block of any one or more of examples 1-10, and/or some other example herein, wherein the body portion further includes a third surface that is adjacent to a fourth surface of the rail when the sliding block is coupled with the rail.

Example 12 may include the sliding block of example 11, and/or some other example herein, wherein the runner is a first runner and wherein the body portion further includes a second runner that at least partially protrudes from the third surface.

Example 13 may include the sliding block of example 11, and/or some other example herein, wherein the runner at last partially protrudes from the third surface.

Example 14 may include the sliding block of any one or more of examples 1-13, and/or some other example herein, wherein the body portion is configured to prevent movement along a second axis that is perpendicular to the length of the rail when the sliding block is coupled with the rail.

Example 15 may include a rail track system comprising: a rail configured to couple with a vehicle; and a sliding block configured to couple with, and traverse at least a portion of a length of, the rail, wherein the sliding block includes a plastic runner that protrudes from a surface of the sliding block that is adjacent to the rail, and wherein the plastic runner is configured to prevent a metal body of the sliding block from physically contacting the rail when the sliding block is coupled with the rail.

Example 16 may include the rail track system of claim 15, and/or some other example herein, wherein the plastic runner protrudes from the surface by between 0.05 and 0.15 thousandths of an inch.

Example 17 may include the rail track system of any one or more of claims 15-16, and/or some other example herein, wherein the plastic runner is a first plastic runner, and wherein the sliding block further includes a second plastic runner that is configured to further prevent the metal body of the sliding block from physically contacting the rail when the sliding block is coupled with the rail.

Example 18 may include the rail track system of claim 17, and/or some other example herein, wherein the second plastic runner protrudes from the surface of the sliding block.

Example 19 may include the rail track system of any one or more of claims 17-18, and/or some other example herein, wherein the surface is a first surface, and wherein the second plastic runner protrudes from a second surface of the sliding block.

Example 20 may include the rail track system of any one or more of claims 15-19, and/or some other example herein, wherein the rail is a metal rail.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

1. A sliding block comprising:
a body portion that includes a metal material, wherein the body portion is configured to traverse a length of a rail when the sliding block is coupled with the rail, and wherein the body portion includes a first face that is adjacent to a second face of the rail when the sliding block is coupled with the rail; and
a runner that protrudes from the first surface, wherein the runner prevents the first surface from being in contact with the second surface when the sliding block is coupled with the rail.

2. The sliding block of claim 1, wherein the rail is configured to be mounted to a vehicle.

3. The sliding block of claim 2, wherein the vehicle is a boat, a truck, or an all-terrain vehicle (ATV).

4. The sliding block of claim 1, wherein the runner is a plastic runner.

5. The sliding block of claim 1, wherein the runner protrudes from the first surface by between 0.05 and 0.15 thousandths of an inch.

6. The sliding block of claim 1, wherein the metal material is aluminum.

7. The sliding block of claim 1, wherein the rail includes aluminum.

8. The sliding block of claim 1, wherein the body portion includes two or more runners that protrude from the first surface.

9. The sliding block of claim 1, wherein the body portion is configured as a female connector and the rail is configured as a male connector.

10. The sliding block of claim 1, wherein the body portion is configured as a male connector and the rail is configured as a female connector.

11. The sliding block of claim 1, wherein the body portion further includes a third surface that is adjacent to a fourth surface of the rail when the sliding block is coupled with the rail.

12. The sliding block of claim 11, wherein the runner is a first runner and wherein the body portion further includes a second runner that at least partially protrudes from the third surface.

13. The sliding block of claim 11, wherein the runner at last partially protrudes from the third surface.

14. The sliding block of claim 1, wherein the body portion is configured to prevent movement along a second axis that is perpendicular to the length of the rail when the sliding block is coupled with the rail.

15. A rail track system comprising:
a rail configured to couple with a vehicle; and
a sliding block configured to couple with, and traverse at least a portion of a length of, the rail, wherein the sliding block includes a plastic runner that protrudes from a surface of the sliding block that is adjacent to the rail, and wherein the plastic runner is configured to prevent a metal body of the sliding block from physically contacting the rail when the sliding block is coupled with the rail.

16. The rail track system of claim 15, wherein the plastic runner protrudes from the surface by between 0.05 and 0.15 thousandths of an inch.

17. The rail track system of claim 15, wherein the plastic runner is a first plastic runner, and wherein the sliding block further includes a second plastic runner that is configured to further prevent the metal body of the sliding block from physically contacting the rail when the sliding block is coupled with the rail.

18. The rail track system of claim 17, wherein the second plastic runner protrudes from the surface of the sliding block.

19. The rail track system of claim 17, wherein the surface is a first surface, and wherein the second plastic runner protrudes from a second surface of the sliding block.

20. The rail track system of claim 15, wherein the rail is a metal rail.
